(19) United States
(12) Patent Application Publication
(10) Pub. No.: US 2003/0202865 A1
(43) Pub. Date: Oct. 30, 2003

(54) Substrate transfer apparatus

(75) Inventors: Hari Ponnekanti, San Jose, CA (US); Vinay K. Shah, San Francisco, CA (US); Michael Robert Rice, Pleasanton, CA (US); Victor Belitsky, Sunnyvale, CA (US); Damon Cox, Round Rock, TX (US); Robert B. Lowrance, Los Gatos, CA (US); Joseph Arthur Kraus, Austin, TX (US); Jeffrey C. Hudgens, San Francisco, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/133,152

(22) Filed: Apr. 25, 2002

(51) Int. Cl. B65G 49/05; B65G 57/11

(52) U.S. Cl. 414/217; 414/939; 414/805; 118/719

(57) ABSTRACT

A wafer handler having a central body with a first end and a central axis of rotation is provided. A first end effector, adapted to support a first wafer, is rotatably coupled to the first end of the central body so as to define a first axis of rotation between the central body and the first end effector. Optionally, a second end effector adapted to support a second wafer is rotatably coupled to the second end of the central body so as to define a second axis of rotation between the central body and the second end effector. When the central body is rotated about the central axis of rotation in a first direction over a first angular distance, the first end effector simultaneously rotates about the first axis of rotation and the optional second end effector rotates about the second axis of rotation. Both end effectors are rotated over a second angular distance that is greater than the first angular distance. One or more of the end effectors may be pocketless.

### FIELD OF THE INVENTION

The present invention relates generally to semiconductor substrate vacuum fabrication systems, and to an improved method and apparatus for increasing system productivity.

### BACKGROUND OF THE INVENTION

Within an automated semiconductor wafer fabrication system, a wafer typically moves from a loadlock chamber to at least one process chamber and then returns to the loadlock after processing. In the vacuum semiconductor processing field, layout of the various system components such as loadlocks, process chambers, intermediate processes (e.g., pre-clean, cooldown) and transfer mechanisms (e.g., robots or conveyors, etc.) is critical to both system cost and reliability, as well as to footprint (i.e., a tool's dimension measured in the plane of the floor) and productivity. Accordingly, much attention is directed to tool layout, as the industry needs to continually improve throughput rates, increase reliability and reduce costs.

### SUMMARY

In a first aspect, an inventive wafer handler comprises a central body with a first end, a second end and a central axis of rotation. A first end effector, adapted to support a first wafer, is rotatably coupled to the first end of the central body so as to define a first axis of rotation between the central body and the first end effector. A second end effector adapted to support a second wafer is rotatably coupled to the second end of the central body so as to define a second axis of rotation between the central body and the second end effector. A drive mechanism is coupled to the central body, the first end effector and the second end effector and is adapted to rotate the central body about the central axis of rotation in a first direction over a first angular distance while simultaneously rotating the first end effector about the first axis of rotation and the second end effector about the second axis of rotation. Both end effectors are rotated over a second angular distance that is greater than the first angular distance.

In a second aspect, an inventive apparatus comprises a transfer chamber, having a first opening through which a substrate may be transferred and a second opening through which a substrate may be transferred. The first and second openings may be positioned opposite each other. A processing chamber may be coupled to the transfer chamber adjacent the first opening, and a wafer handler may be contained within the transfer chamber. The wafer handler may have an end effector adapted to selectively carry a substrate through the first and second openings. In one such aspect, the wafer handler may have two end effectors adapted to simultaneously extend through the first and second openings.

An inventive method comprises placing a substrate on a substrate support within a first chamber. Thereafter, the substrate is extracted via a substrate handler having a pocketless end effector. During such extraction, the substrate handler extends a first distance. Thereafter the substrate is transported via the substrate handler to a second chamber, and the substrate handler again extends the first distance to place the substrate in the second chamber while the substrate handler is extended the first distance.

A further inventive method comprises providing a symmetrical robot having pocketless blades mounted so as to selectively extend in opposite directions upon robot rotation. While the robot's first pocketless blade extends in a first direction, and the second pocketless blade extends in a second direction, two substrates are simultaneously picked up. Thereafter the robot is rotated such that the substrates simultaneously pass over the robot's center, and such that the robot's first pocketless blade extends in the second direction, and the second pocketless blade extends in the first direction.

### BRIEF DESCRIPTION OF THE DRAWINGS

FIGS. 1A-C are top plan views of an inventive substrate transfer tool;

FIGS. 2A-C show an alternative embodiment of the substrate transfer tool wherein the transfer chamber comprises a substrate handler having two end effectors rotatably coupled to the central body at opposite ends thereof;

FIGS. 3A and 3B are schematic side views which respectively show a blocker in position to block a first opening, and in position to allow one of the end effectors to transport a wafer through the first opening;

FIGS. 4A and 4B are top plan views of an inventive substrate handler, showing an exemplary drive mechanism therefore;

FIG. 5 is a schematic top plan view of the inventive substrate handler showing the transmission elements of FIGS. 4A-4B in an aspect that employs magnetic coupling;

FIG. 6 is a schematic top plan view of the inventive substrate handler showing the transmission elements of FIGS. 4A-4B in an aspect that employs overlapping magnets; and FIG. 7 is a top plan view showing the inventive substrate transfer apparatus coupled between a docking platform and a loadlock chamber.

### DETAILED DESCRIPTION OF THE DRAWINGS

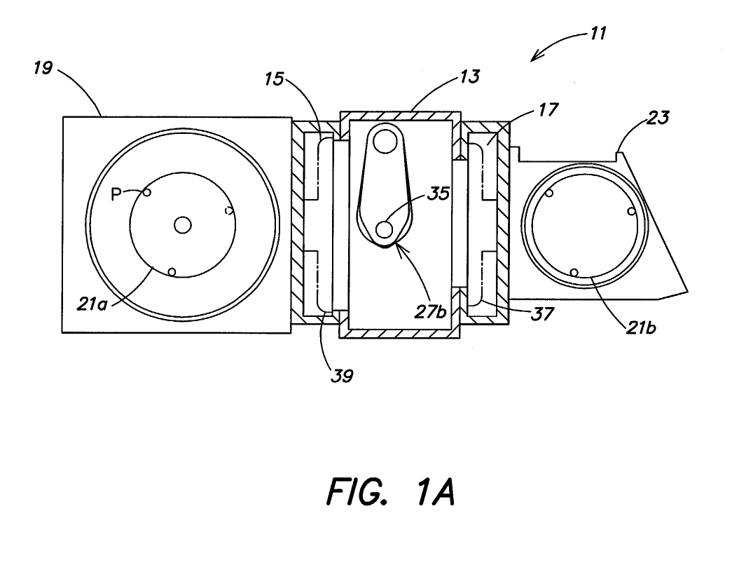

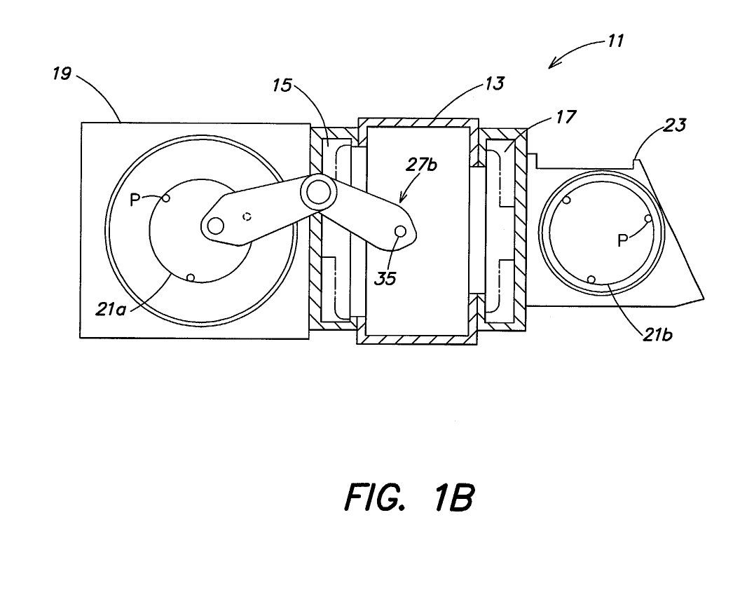

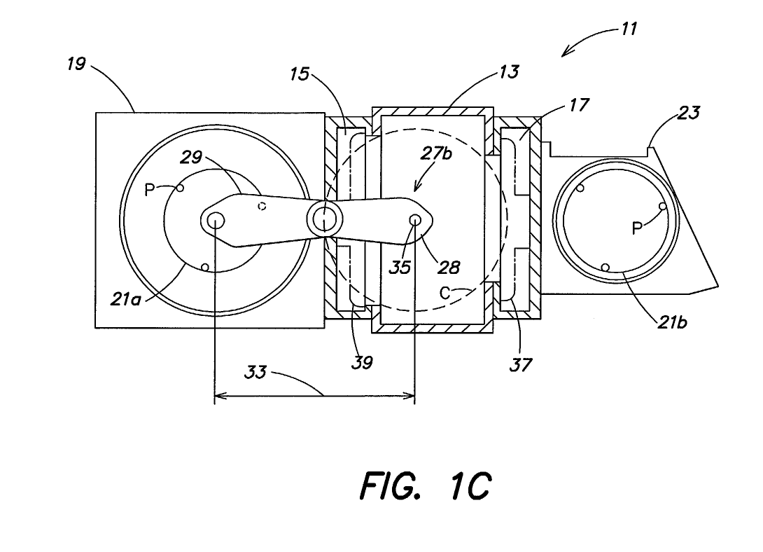

FIGS. 1A-C are top plan views of an inventive substrate transfer tool 11 comprising a transfer chamber 13 having a first opening 15 through which a substrate may be transferred, and a second opening 17 through which a substrate may be transferred. The first opening and the second opening are positioned opposite each other (e.g., on opposite sides of the transfer chamber 13 so that a straight line may be drawn across the transfer chamber 13 and through both the first opening 15 and the second opening 17). A first chamber 19 (e.g., a processing chamber or a loadlock chamber for pumping and venting between vacuum and atmospheric pressures) is coupled to the transfer chamber 13 adjacent the first opening 15 and contains a substrate support 21a. A substrate loading tool 23 (such as a docking station for receiving a substrate carrier, or a loadlock chamber) is coupled to the transfer chamber 13 adjacent the second opening 17 and contains a substrate support 25b.

The transfer chamber 13 contains a wafer handler 27a having a rotatable central body 28, an end effector 29 rotatably coupled to the central body 28 and adapted to selectively extend through the first opening 15 and the second opening 17. FIGS. 1A-C show the wafer handler 27a sequentially moving from a retracted position to an extended position. As shown, the end effector 29 may begin to extend through the first or second opening 15, 17 without need to be centered in front of opening 15, 17.

Preferably the end effector 29 is able to support a horizontal substrate in various locations along the length of the end effector 29 (i.e., is “pocketless”). Provided the end effector 29 is pocketless, it is able to reliably pick and place substrates from the first chamber 19 and the substrate loading tool 23 regardless of any temperature induced changes in the dimensions of the end effector 29 or the central body 28. The substrate handler 27 preferably is an extendable Selective Compliance Robot Assembly (SCARA) arm type handler with a series of vertically oriented joints, and internal transmission that generates straight line motion of the end effector 29.

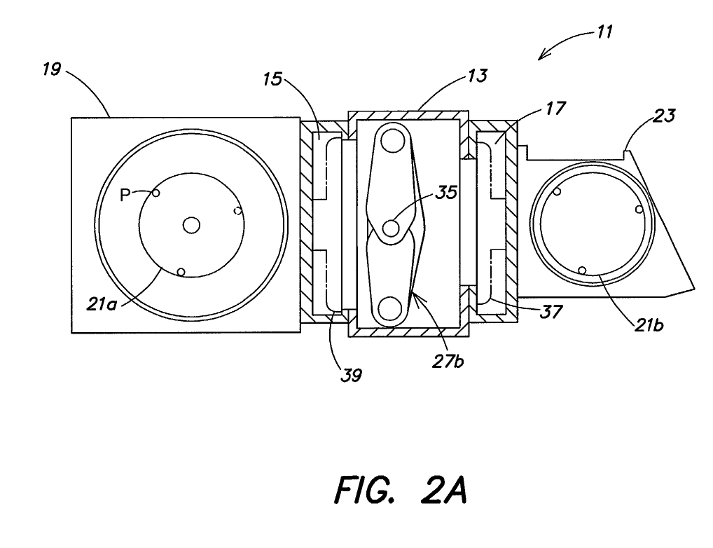

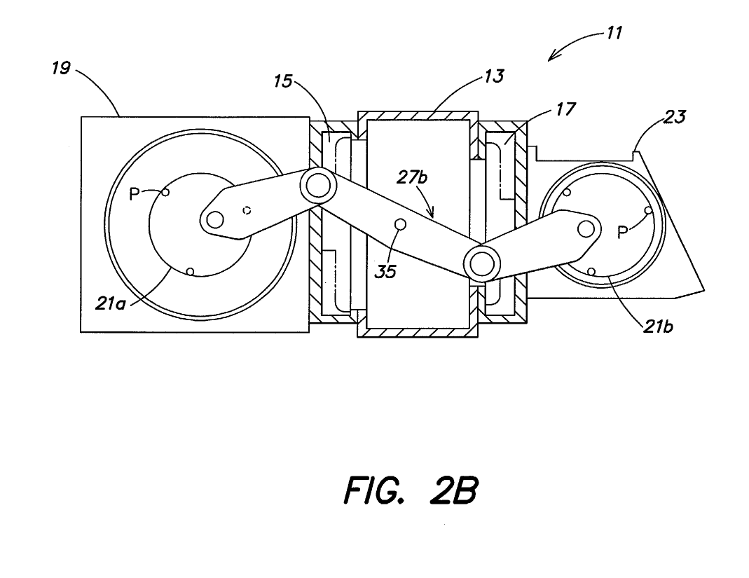

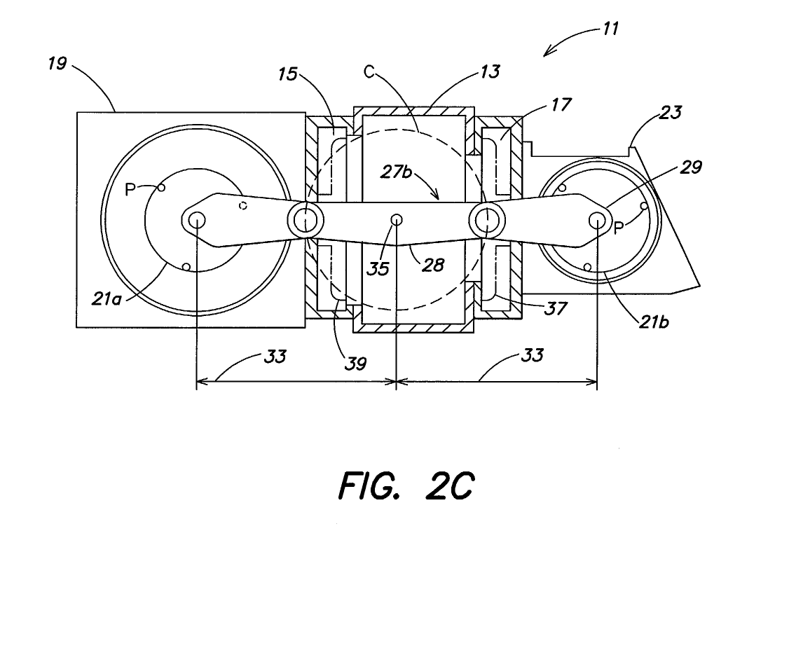

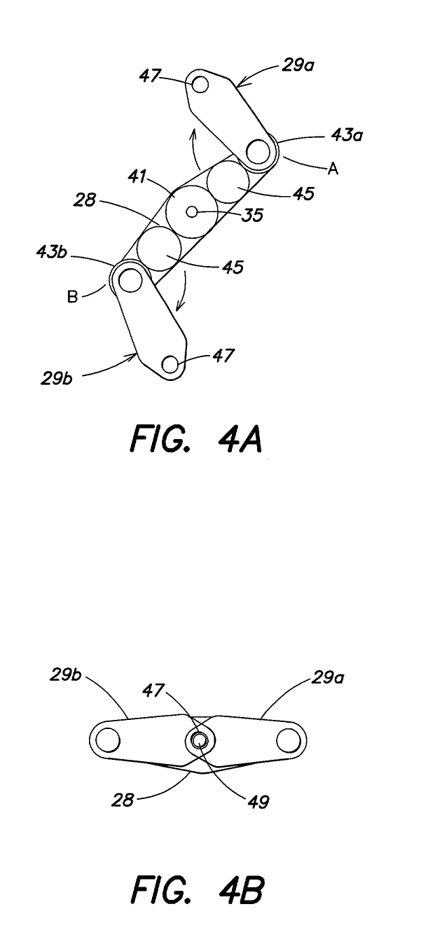

FIGS. 2A-C show an alternative embodiment of the inventive substrate transfer tool 11 wherein the transfer chamber 13 thereof comprises a substrate handler 27b having two end effectors 29a, 29b rotatably coupled to the central body 28 at opposite ends thereof. The substrate handler 27b is adapted to simultaneously extend the two end effectors 29a, 29b through the first opening 15 and the second opening 17, as described in detail with reference to FIG. 4 below. Like the substrate handler 27a, the end effectors 29a, 29b of the substrate handler 27b both preferably are pocketless.

General Tool Operation

The substrate transfer tools 11 of FIGS. 1A-C and 2A-C operate similarly, with the substrate handler 27a, 27b assuming a retracted position when its main body 28 is generally parallel to the first opening 15 and the second opening 17 (FIGS. 1A and 2A), and extending therefrom while rotating either clockwise or counterclockwise until the main body 28 is generally fully perpendicular to the first opening 15 and the second opening 17 with the end effector(s) 29a, 29b extended through the first opening 15 and/or the second opening 17 to position a substrate supported on the end effector(s) 29a, 29b above the substrate support 21a and/or the substrate support 21b, as sequentially shown in FIGS. 1B-C and 2B-C, respectively.

Notably, the main body 28's circumference of rotation C may overlap the first opening 15 and the second opening 17 as shown. In this manner the area of floor space (i.e., the footprint) occupied by the transfer chamber 13 may be reduced, and the overall distance a substrate must travel may also be reduced, allowing substrate transfer to occur more quickly without increasing the speed at which a substrate travels. Accordingly, substrates may be expeditiously exchanged without sliding along the end effector 29a, 29b.

When the end effector(s) 29a, 29b are above the substrate support 21a, 21b, the substrate handler 27a, 27b may lower, such that the end effector(s) 29a, 29b lower between a plurality of pins P located at the substrate supports 21a, 21b. Alternatively the pins P located at the substrate supports 21a, 21b may elevate to lift the substrate from the end effector 29a, 29b.

Preferably, the pins P of both the processing chamber 13 and the loadlock chamber 23 are adapted to lift and lower so as to extract and/or place a substrate on the end effector 29a, 29b. In this manner, the substrate handler 27a, 27b may be more reliable and less expensive. Similarly, when the substrate handler 27a, 27b is to extract substrates from a substrate carrier comprising a plurality of substrates, the docking station on which the carrier is located may be adapted to lift and lower. The docking station may index so that each substrate is sequentially positioned at the substrate handler's elevation.

Platform Calibration Process

To calibrate the substrate transfer tool 11, the substrate handler 27a, 27b is placed equidistantly between the substrate supports 21a, 21b. Because the end effectors 29a, 29b are pocketless, they pick up wafers from the substrate supports 21a, 21b regardless of a specific distance 33 between a central axis of rotation 35 of the substrate handler 27a, 27b and each of the substrate supports 21a, 21b. Also, because the substrate supports 21a, 21b are equidistant from the substrate handler 27's central axis of rotation 35, a substrate picked up from one of the substrate supports 21a, 21b and transferred to the other of the substrate supports 21a, 21b will automatically be properly positioned thereon. Accordingly, the substrate transfer tool 11 may be simply calibrated via positioning the substrate supports 21a, 21b and the central axis of rotation 35 of the substrate handler 27 equidistantly and in a straight line, as shown.

In order to precisely place a wafer at a desired location within a processing chamber (e.g., in this example, at the center of the processing chamber) a wafer is placed (by any means) exactly in the center of the processing chamber. The inventive substrate handler 27 then extracts the wafer from the center of the processing chamber 19 and places the wafer on a pocketless shelf or set of pins within the loadlock chamber 23. The exact location of the wafer within the loadlock chamber 23 is then determined (e.g., by manually teaching a robot that loads and unloads the loadlock chamber 23, by locating the wafer's edge using sensors attached to the edge of the loader robot's blade, or by using sensors integrated with the loadlock chamber). Subsequent wafers are placed on the determined, exact location within the loadlock chamber 23. Provided the same end effector 29 that was employed during the calibration transfer is used during subsequent transfer between the loadlock chamber 23 and processing chamber 19, transferred wafers will be precisely placed in the exact center of the processing chamber 19, and at the determined exact location within the loadlock chamber 23. Thus, transfer from the loadlock chamber 23 to the processing chamber 19 may be restricted so as to be performed always by the same end effector 29. Alternatively, if both end effectors 29a, 29b are employed to transfer wafers from the loadlock 23 to the processing chamber 19, an exact location for wafer placement within the loadlock 23 may be determined for each respective end effector 29a, 29b.

Chamber Isolation

The first opening 15 and the second opening 17 of the substrate transfer tool 11 may be selectively sealed by valves, such as conventional slit valves or gate valves as are well known in the art, or may be selectively obstructed by non-sealing objects (i.e., blockers) adapted to selectively block the respective opening 15, 17 and sized so as to deter mingling between environments of the adjoining regions. Thus, the inventive substrate transfer tool 11 may provide considerable processing variety.

Whether a slit valve, gate valve, blocker or other mechanism is employed depends on the operation to be performed by the first chamber 19, the specific loading tool 23 (e.g. loadlock, or docking station with or without automatic door opener), and whether or not the transfer chamber 13 is to be maintained at vacuum pressure, atmospheric pressure or to be pumped and vented between vacuum and atmospheric pressure.

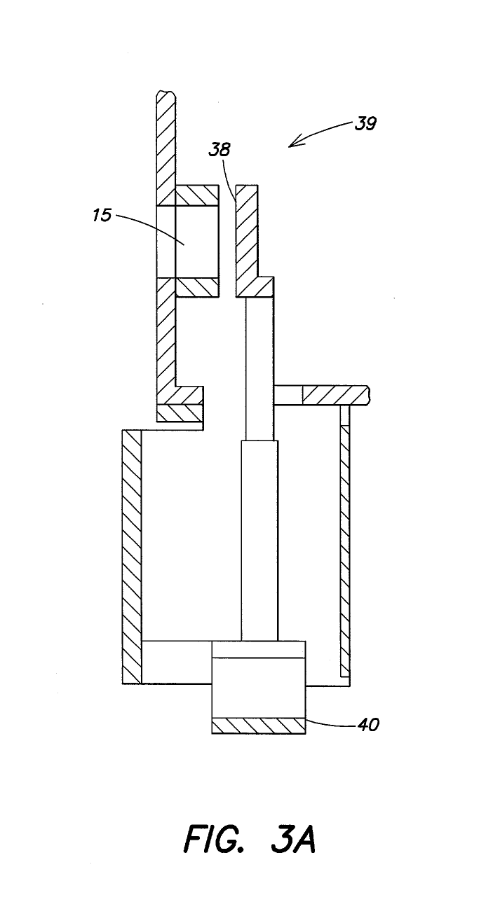

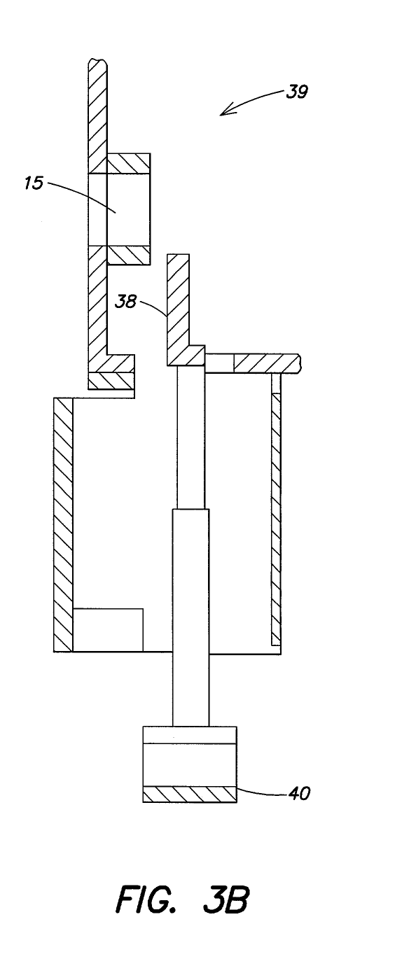

When FIGS. 1A-2C are configured for plasma processing, a slit valve (generally represented in phantom by 37) selectively seals the second opening 17 between the transfer chamber 13 and the substrate loading tool 23, and a blocker 39 (see FIGS. 3A and 3B) may selectively block the first opening 15 between the transfer chamber 13 and the first chamber 19 (e.g., in this example processing chamber 19). The processing chamber 19 may be a conventional plasma processing chamber such as an etch or deposition chamber.

FIGS. 3A and 3B are schematic side views which show a blocker 39 in position to block the first opening 15 (FIG. 3A) and in position to allow one of the end effectors 29a, 29b to transport a wafer through the first opening 15 (FIG. 3B). The blocker 39 may be configured much like any conventional slit valve, but need not include sealing mechanisms such as o-rings and horizontal actuators. For example, the blocker 39 may comprise a blocking plate 38 sized so as to at least cover the opening 15. The blocking plate 86 may be positioned in close proximity to the opening 15, and may be coupled to a vertical actuator 40 for lifting and lowering the blocking plate 38 between the positions shown in FIGS. 3A and 3B.

The substrate loading tool 23 (In this example referred to as loadlock 23) may be any conventional loadlock, whether configured to support only a single substrate or a plurality of substrates.

Assuming the processing chamber 19 and the transfer chamber 13 are continuously maintained at a vacuum pressure, the transfer chamber 13 may have its own vacuum pump or may be pumped out via the vacuum pump of the processing chamber 19.

The operation of the substrate transfer tool of FIGS. 1A-C is now described. Initially, one or more substrates are placed in the loadlock chamber 23, and the loadlock chamber 23 is pumped to a vacuum pressure. The slit valve 37 positioned between the loadlock chamber 23 and the transfer chamber 13 then opens, the substrate handler 27a, rotates and extends to position its first end effector 29a under a substrate supported in the loadlock 23 by the plurality of pins P. The pins P lower, transferring the substrate to the first end effector 29a. The substrate handler 27a then retracts (FIGS. 2A-B), rotates 180° extends holding the unprocessed substrate above the pins P in the processing chamber 19. The retraction and rotation process is described in detail under the heading “Substrate Handler”.

Thereafter the slit valve 37 elevates, the pins P in the processing chamber 19 extend, lifting the substrate from the end effector 29a, and the substrate handler 27a retracts and rotates 90° to its central-retracted position (FIG. 2A). The pins P lower, positioning the substrate on the substrate support 21a, and the blocker 39 elevates. A plasma may be generated in the processing chamber 19 and may be deterred or prevented from entering the transfer chamber 13 via the blocker 39.

Assuming a loadlock 23 having a pair of vertically stacked, vertically indexable wafer supporting slots is employed, the wafer supporting slots elevate to position an empty wafer supporting slot just below the elevation of the end effector 27a. After processing is complete, the blocker 39 lowers (as does the slit valve 37 if it was previously elevated), the pins P raise the substrate above the substrate support 21a, the substrate handler 27a rotates 90° extending into the processing chamber 19 beneath the processed substrate, and the pins P lower the substrate onto the end effector 29a. The substrate handler 27a then rotates 180° retracting and extending as described in detail in the next section, until the substrate is positioned above the empty wafer supporting slot of the loadlock 23. Thereafter the supporting slot elevates lifting the substrate from the end effector 29a. The supporting slots of the loadlock 23 elevate to place a substrate on the end effector 29a. It will be understood that in some instances the end effector 29a may need to retract and then extend to allow positioning of an occupied substrate supporting slot above the end effector 29a for substrate transfer.

The substrate handler 27a retracts, and the slit valve 37 closes. The loadlock 23 is then vented to atmospheric pressure, the processed substrate is extracted therefrom and an unprocessed substrate is loaded into the loadlock 23, while the unprocessed substrate is transferred to the processing chamber 19. Thereafter the process repeats for each new substrate loaded into the loadlock 23.

The operation of the substrate transfer tool of FIGS. 2A-C is similar to the operation described above with reference to FIGS. 1A-C. The primary difference being that the substrate transfer tool of FIGS. 2A-C may be more efficiently employed with a loadlock 23 that has only a single slot. With reference to FIGS. 2A-c (assuming a single slot loadlock), a substrate is loaded into the loadlock 23 and the loadlock 23 is pumped down. Assuming a processed substrate is contained in the processing chamber 19, the slit valve 37 and blocker 39 lower, the substrate handler 27b rotates 90° from the retracted, centered position to the extended position below substrates supported on elevated pins P within the processing chamber 19 and the loadlock 23. The pins P lower, the substrate handler rotates 180° simultaneously transporting the processed substrate to the loadlock 23 and the unprocessed substrate to the processing chamber 19. The pins P raise lifting the substrates from the end effectors 29a, 29b, and the substrate handler 27b rotates 90° bringing the empty end effectors 29a, 29b to the retracted, centered position. Thereafter the slit valve 37 and blocker 39 elevate, substrate processing proceeds in the processing chamber 19 and wafer exchange occurs in the loadlock 23. Thereafter the process repeats.

As described above, in one aspect the inventive substrate transfer tool 11 may allow faster substrate transfer due to shorter traveling distance if the substrate handler's circumference of rotation C extends beyond the openings 15 and 17. An exemplary substrate handler and its operation is described below.

Substrate Handler

FIGS. 4A and 4B are top plan views of an inventive substrate handler, showing an exemplary drive mechanism therefore. In the aspect shown, the substrate handler 27b comprises a central body 28 having a first end A, a second end B, and a central axis of rotation 35. The first end effector 29a is rotatably coupled to the first end A of the central body 28 thereby defining a first axis of rotation, between the central body 28 and the first end effector 29a. The second end effector 29b is rotatably coupled to the second end B of the central body 28 thereby defining a second axis of rotation, between the central body 28 and the second end effector 29b.

A drive mechanism which may comprise a motor (not shown) and gears is coupled to the central body 28 and to the first and second end effectors 29a, 29b. The drive mechanism may be adapted to rotate the central body 28 about the central axis of rotation 35 while simultaneously rotating the first and second end effectors 29a, 29b. Preferably the gears are selected so that first and second end effectors 29a, 29b rotate an angular distance that is greater than the angular distance rotated by the central body 28. For example, the drive mechanism may comprise a central gear 41 located at the central body 28's central axis of rotation 35, and a first and second end effector gear 43a, 43b that rotatably couple the first and second end effectors 29a, 29b to the central body 28. Preferably the central gear 41 and the first and second end effector gears 43a, 43b have a 2 to 1 ratio and are operatively coupled to each other (either directly or through intermediate gears 45) so that the first and second end effectors 29a, 29b rotate 180° as the central body 28 rotates 90° . It will be understood, that the central gear 41 may be fixedly coupled to the central body 28 so that rotation of the central gear 41 causes the central body 28 to rotate therewith. Alternatively the central gear 41 may be fixed with respect to ground and a single motor may drive the rotation of central body 28. It will be understood that many other drive mechanisms may be employed, such as belts, bands or linkages.

Because rotation of both the central body 28 and the end effectors 29a, 29b is actuated by the same motor, and because the central gear 41, and the end effector gears 43a-b are chosen so that the rotation of the first end effector 29a is equal to the rotation of the second end effector 29b, substrate pick up and placement may occur at a precise location regardless of which end effector 29a, 29b is performing the pick or place operation. To ensure precise alternating end effector pick/place operation the two end effectors 29a, 29b should be coupled an equal distance from the central body 28's central axis of rotation 35. In this manner because the substrate handler 27b is symmetrical, precise alignment of the end effectors 29a, 29b within each chamber (e.g., loadlock chamber 23 and processing chamber 19) is not required.

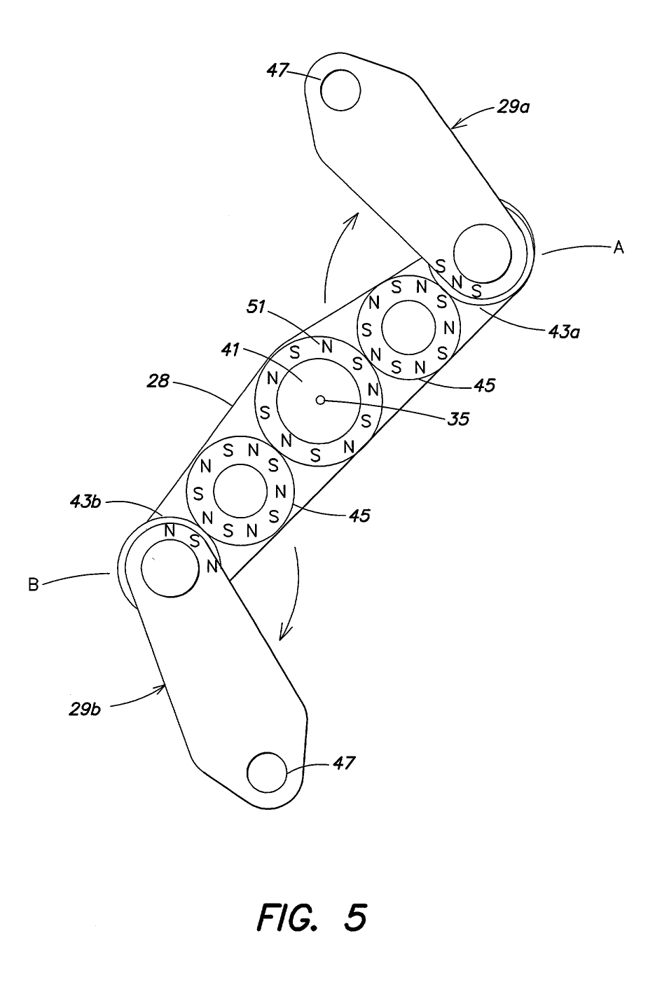

One method of ensuring that the end effectors 29a, 29b are coupled at equal distances from the central body 28's central axis of rotation 35 is via a kinematic alignment mechanism such as a hole 47 located at the same location on both the first and second end effectors 29a, 29b. In this manner, when the first and second end effectors 29a, 29b assume a centered position (e.g., both centered above or below the central body 28) as shown in FIG. 4B, the holes 47 are aligned such that an alignment pin 49 may be inserted through the overlapping holes 47. The diameter of the alignment pin 49 may be chosen so that the alignment pin 49 will not be insertable through the two holes 47 unless the holes 47 (and thus the end effectors 29a, 29b) are properly positioned. In one aspect the gears may be magnetically coupled as shown in FIG. 5.

FIG. 5 is a schematic top plan view showing the gears of FIGS. 4A-4B in an aspect that employs magnetic coupling rather than conventional intermeshed teeth. As shown in FIG. 5 each gear comprises a circular arrangement of magnets 51. The magnets 51 are arranged so as to alternate between magnets having a North polarity and magnets having a South polarity. Adjacent gears are positioned so as to attract the magnets of the adjacent gear (e.g., a North magnet of the central gear 41 is positioned adjacent a South magnet of the intermediate gears 45). Thus when the central gear 41 rotates, the attractive force between the magnets 51 of the central gear 41 and the intermediate gears 45 causes the intermediate gears 45 to rotate.

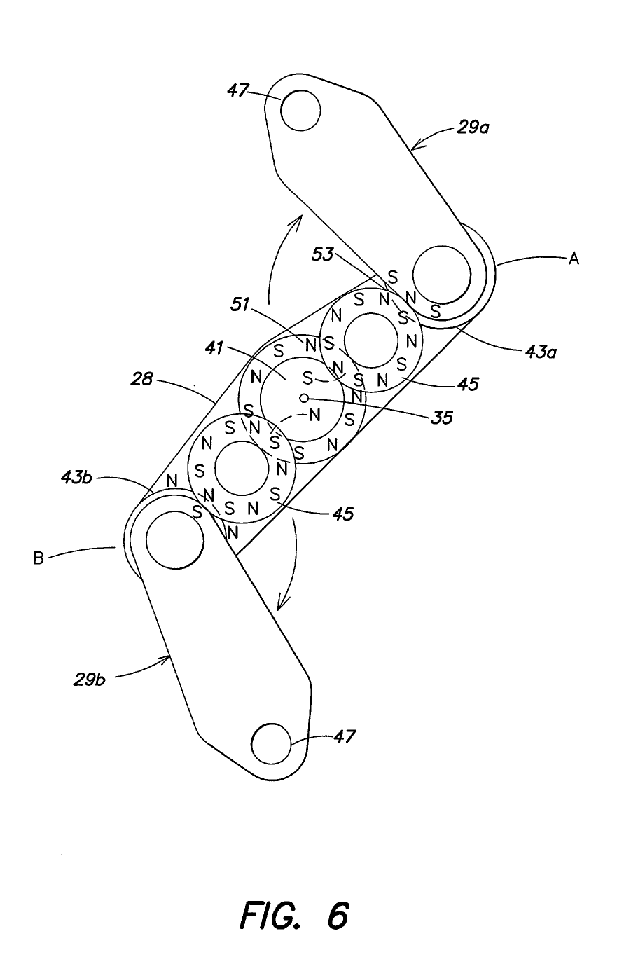

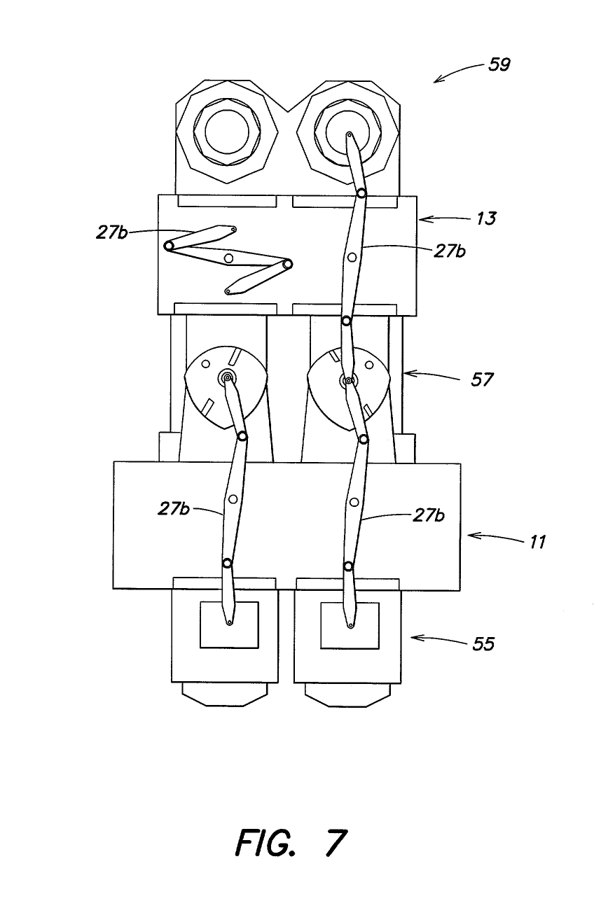

This embodiment provides reduced contact between moving parts, and thus may reduce particle generation and increase part life. Also, because at any given time the attractive magnetic fields of more than one pair of magnets may contribute to gear rotation, smooth rotation may result without the cogging that can occur with intermeshed teeth. Additionally, magnetic coupling allows the gears to be positioned so that adjacent gears overlap (as shown by the areas indicated as 53 in FIG. 6), thereby allowing the drive assembly to have a reduced footprint. The magnetic gears may be selected so as to deliver a desired ratio of input rotation to output rotation, and, although not shown, may translate rotation in one plane into rotation in another plane.

FIG. 7 is a top plan view showing the inventive substrate transfer tool 11 coupled between a docking platform 55 and a loadlock chamber 57. In the embodiment of FIG. 7, the substrate transfer tool may comprise a single transfer chamber 13 that contains two of the inventive substrate handlers 27b. The docking platform 55 may comprise the docking platform of Applied Materials, Inc.'s Bay Distributed Stocker, and may include a mechanism for opening the door of a sealed substrate carrier. The docking platform may be adapted so as to vertically index a substrate carrier positioned thereon, so that the substrate handler of the substrate transfer tool 11 need not perform z-axis motion. An exemplary apparatus for both opening a sealed substrate carrier and for indexing the carrier vertically to facilitate substrate extraction is disclosed in U.S. patent application Ser. No. 09/882,130, filed Jun. 14, 2001 and titled Pod Door Opener (AMAT No. 4026/P1), the entire disclosure of which is incorporated herein by this reference.

The loadlock chamber 57 may be part of a commercially available processing tool such as the Applied Materials' Producer™ platform 59. As shown in FIG. 7, the standard Producer™ platform has been modified to include a pair of the inventive substrate handlers 27b.

The foregoing description discloses only a preferred embodiment of the invention; modifications of the above disclosed apparatus which fall within the scope of the invention will be readily apparent to those of ordinary skill in the art. For instance, the substrate handler's drive mechanism may comprise a linkage arrangement, belts, bands, or any other such conventional mechanism. The motor that actuated the drive mechanism may comprise a vacuum motor, a magnetically coupled motor, a ferrofluidicly coupled motor, a differential lip seal motor, an eccentric bellow drive, or a vacuum isolated harmonic drive.

Although the exemplary substrate transfer tool described herein is configured with openings on opposing sides of the transfer chamber, the openings may be located at other locations, and the substrate handler design (end effector and central body shape and dimensions, and gear ratios) modified accordingly.

Further, it will be understood, that the apparatus of FIG. 7 alternatively may include inventive substrate handlers 27a having only a single end effector. The number of inventive substrate handlers 27a or 27b contained in either transfer chamber 11 or 13 may vary (e.g., one or more). In one aspect, the transfer chamber 11 may be replaced with an Applied Materials Factory Interface Chamber, that comprises a single bladed wafer handler that travels along a track to position itself in front of the desired load lock 57 or docking platform 55. Also the docking platforms 55 may comprise an Applied Materials automatic door opener platform.

Accordingly, while the present invention has been disclosed in connection with exemplary embodiments thereof, it should be understood that other embodiments may fall within the spirit and scope of the invention, as defined by the following claims.

The invention claimed is:

1. A wafer handler comprising:
a central body having a first end, a second end and a central axis of rotation;
a first end effector adapted to support a first wafer; and rotatably coupled to the first end of the central body so as to define a first axis of rotation between the central body and the first end effector,
a second end effector adapted to support a second wafer and rotatably coupled to the second end of the central body so as to define a second axis of rotation between the central body and the second end effector,
a drive mechanism coupled to the central body, the first end effector and the second end effector and adapted to rotate the central body about the central axis of rotation in a first direction over a first angular distance while simultaneously rotating the first end effector about the first axis of rotation and the second end effector about the second axis of rotation over a second angular distance that is greater than the first angular distance.

2. the apparatus of claim 1 wherein the second angular distance is twice that of the first angular distance, such that when the central body rotates 180° the first and second end effectors rotate 360° relative to the central body.

3. The apparatus of claim 2 wherein the drive mechanism comprises:
a central gear located at the central body's central axis of rotation;
a first end effector gear that rotatably couples the first end effector to the central body; and
a second end effector gear that rotatably couples the second end effector to the central body;
wherein the central gear and the first end effector gear have a 2 to 1 ratio; the central gear and the second end effector gear have a 2 to 1 ratio, and the first and second end effector gears are operatively coupled to the central gear so as to rotate therewith.

4. The apparatus of claim 1 wherein the first and second end effectors are pocketless.

5. The apparatus of claim 2 wherein the first and second end effectors are pocketless.

6. The apparatus of claim 3 wherein the first and second end effectors are pocketless.

7. The apparatus of claim 4 wherein the first and second end effectors each have a calibration hole positioned so that the calibration holes are aligned when the first and second end effectors are in a central position.

8. The apparatus of claim 5 wherein the first and second end effectors each have a calibration hole positioned so that the calibration holes are aligned when the first and second end effectors are in a central position.

9. The apparatus of claim 6 wherein the first and second end effectors each have a calibration hole positioned so that the calibration holes are aligned when the first and second end effectors are in a central position.

10. An apparatus comprising:
a transfer chamber, having a first opening through which a substrate may be transferred and a second opening through which a substrate may be transferred, the first and second openings being positioned opposite each other;
a processing chamber coupled to the transfer chamber adjacent the first opening;
a wafer handler contained within the transfer chamber, the wafer handler having an end effector adapted to carry a substrate through the first and second openings.

11. The apparatus of claim 10 wherein the wafer handler is pocketless.

12. The apparatus of claim 10 wherein the wafer handler is a SCARA.

13. The apparatus of claim 10 wherein the wafer handler has two end effectors adapted to simultaneously extend through the first and second openings.

14. The apparatus of claim 13 wherein the wafer handler is a SCARA.

15. The apparatus of claim 13 wherein both end effectors are pocketless.

16. The apparatus of claim 14 wherein both end effectors are pocketless.

17. The apparatus of claim 10 further comprising a non-sealing object adapted to selectively block the first opening and sized so as to deter environmental mingling between the processing chamber and the transfer chamber when blocking the first opening.

18. The apparatus of claim 10 further comprising a non-sealing object adapted to selectively block the first opening and sized so as to deter a plasma from exiting the processing chamber through the first opening when blocking the first opening.

19. The apparatus of claim 17 further comprising a substrate loading chamber coupled to the transfer chamber adjacent the second opening and adapted to selectively generate a vacuum pressure in the substrate loading chamber; and a valve adapted to selectively seal the second opening.

20. The apparatus of claim 19 further comprising a substrate loading chamber coupled to the transfer chamber adjacent the second opening and adapted to selectively generate a vacuum pressure in the substrate loading chamber; and a valve adapted to selectively seal the second opening.

21. The apparatus of claim 17 further comprising a substrate loading chamber coupled to the transfer chamber adjacent the second opening and adapted to selectively generate a vacuum in the substrate loading chamber;
a first valve adapted to selectively seal the first opening; and
a second valve adapted to selectively seal the second opening.

22. The apparatus of claim 10 further comprising an automatic door opener coupled to the transfer chamber adjacent the second opening; and
a valve adapted to selectively seal the second opening.

23. The apparatus of claim 22 wherein the automatic door opener comprises an indexing mechanism.

24. The apparatus of claim 22 further comprising a valve adapted to selectively seal the first opening.

25. The apparatus of claim 10 further comprising a frame supporting the transfer chamber and the processing chamber, and rolling elements coupled to the bottom of the frame.

26. A method comprising:
placing a substrate on a substrate support within a first chamber;
extracting the substrate with a substrate handler having a pocketless end effector by extending the substrate handler a first distance;
transporting the substrate via the substrate handler to a second chamber;
extending the substrate handler the first distance; and
placing the substrate in the second chamber while the substrate handler is extended the first distance.

27. The method of claim 26 further comprising positioning a substrate support of the second chamber such that the substrate handler places the substrate on the substrate support.

28. The method of claim 27 further comprising securing the substrate support after it is positioned such that the substrate handler places the substrate thereon.

29. The method of claim 27 wherein positioning the substrate support comprises positioning the second chamber.

30. The method of claim 26 wherein the first chamber comprises a processing chamber and the second chamber comprises a loadlock.

31. A method comprising:
providing a symmetrical robot having pocketless blades mounted so as to selectively extend in opposite directions upon robot rotation;
simultaneously picking up two substrates while the robot's first pocketless blade extends in a first direction, and the second pocketless blade extends in a second direction;
rotating the robot such that the substrates simultaneously pass over the robot's center;
continuing rotating the robot such that the robot's first pocketless blade extends in the second direction, and the second pocketless blade extends in the first direction.
